(19) United States
(12) Patent Application Publication
(10) Pub. No.: US 2003/0086759 A1
(43) Pub. Date: May 8, 2003

(54) Bezel-alignment-and-retention feature for use with electronic devices

(76) Inventors: Michael Leslie Wortman, Sacramento, CA (US); Stephan Karl Barsun, Auburn, CA (US)

Correspondence Address: HEWLETT-PACKARD COMPANY, Intellectual Property Administration, P.O. Box 272400, Fort Collins, CO, 80627-2400, US

(21) Appl. No.: 10/053,108

(22) Filed: Nov. 2, 2001

(51) Int. Cl. F16B 1/00; B25G 3/36; E04G 7/00

(52) U.S. Cl. 403/403

(57) ABSTRACT

A number of snap-retention features, molded onto the inner surface of a bezel, used to guide and fasten a bezel to an equipment enclosure. Each snap-retention feature contains one or more ramp-shaped pieces flanked by two tapered guide strips. As the bezel is closed against the equipment enclosure, the guide strips guide the snap-retention feature along a snap, projecting from the equipment enclosure. The snap is guided up the ramp-shaped pieces. The snap gains tension ascending the ramp-shaped pieces. When the convex tip of the snap crests the ramp-shaped pieces, tension is released in the snap, causing the convex tip of the snap to stay fastened to the back edges of the ramp-shaped pieces.

### TECHNICAL FIELD

The present invention relates to bezels for electronic devices, and, in particular, to a feature that aligns and fastens a bezel to an equipment enclosure.

### BACKGROUND OF THE INVENTION

Typically, electronic devices are housed in standardized equipment enclosures. Many equipment enclosures include an outer housing that is supported by an inner rack. The inner rack usually comprises a substantially rectilinear metal frame including several vertical columns, each provided with a plurality of mounting and alignment holes that permit the mounting of various components to the inner rack.

Many equipment enclosures also include a removable bezel that forms an aesthetic front face for the enclosure. The bezel may also shield internal components from environmental contaminants, such as moisture and dust, as well as shield the environment from noise generated by components within the enclosure. Removing the bezel provides access to components mounted within the enclosures in order to repair, replace, inspect, and perform maintenance tasks on the components.

One current method used to fasten bezels to equipment enclosures employs a snap-on fastening mechanism. A snap-on design generally incorporates a number of snaps, which are either spaced around the edge of the front face of an equipment enclosure or around the perimeter of the interior lip of the bezel. Each snap is fastened to a corresponding retention-apparatus on the interlocking surface. Most snap-on designs also contain an apparatus to properly guide the bezel onto the equipment enclosure. As the guidance-system aligns the bezel with the equipment enclosure, each snap and corresponding retention-apparatus are subsequently aligned.

Many snap-on bezel designs employ a series of separate and distinct features, molded onto the bezel, for bezel-guidance and snap retention. Each feature must be molded as part of the bezel. Thus, every additional feature increases mold complexity and tooling-time expense. Consequently, molded bezels incorporating a snap-on fastening mechanism are expensive and time-consuming to manufacture. For these reasons, designers, manufacturers, and consumers of electronic devices have recognized the need for an integrated bezel-guidance and bezel-retention feature.

### SUMMARY OF THE INVENTION

In one embodiment of the present invention, a bezel-alignment-and-retention system, comprising one or more snap-retention features molded onto the inner lip of a bezel in a single mold, serves to guide and fasten a bezel to an equipment enclosure. Each snap-retention feature comprises two tapered guide strips flanking one or more ramp-shaped pieces. As the bezel approaches a final, flush position against the equipment enclosure, the tapered guide strips guide the convex tip of a snap, projecting from the equipment enclosure, up the ramp-shaped pieces, causing tension to build in the snap. When the convex tip of the snap passes over the back edge of the ramp-shaped pieces within the snap, tension is released within the snap, and the snap stays secured to the back edge of the ramp-shaped pieces.

### BRIEF DESCRIPTION OF THE DRAWINGS

FIG. 1 is a perspective view of a bezel containing a snap-retention feature, and an equipment enclosure containing a snap.

FIG. 2 is a close-up, perspective view of a snap-retention feature molded onto the inner lip of a bezel.

FIG. 3 is a perspective view of one possible snap compatible with a snap-retention section of a snap-retention feature.

FIG. 4A is a perspective view of a snap before climbing two ramp-shaped pieces.

FIG. 4B is a perspective view of a snap after cresting two ramp-shaped pieces.

FIG. 5 is a perspective view showing a snap fastened to a snap-retention section of a snap-retention feature.

### DETAILED DESCRIPTION OF THE INVENTION

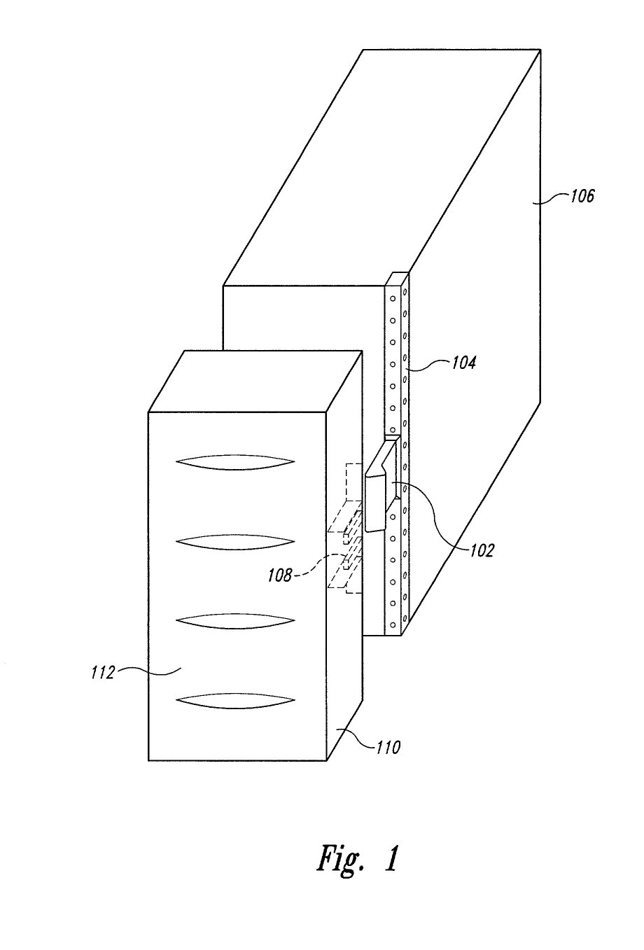

In one embodiment of the present invention, shown in FIGS. 1-5, a number of snap-retention features are molded onto the interior of a bezel in a single mold. FIG. 1 is a perspective view of a bezel 112 containing the snap-retention feature 108, and an equipment enclosure 106 containing a snap 102. The snap-retention feature 108 is molded onto the inner lip 110 of the bezel. The snap 102, compatible with the snap-retention feature 108, is shown anchored to the front face of a vertical column 104 of an inner rack within an equipment enclosure 106. The snap 102 protrudes outward, away from the front face of the equipment enclosure 106, enabling the snap 102 to fasten to the snap-retention feature 108. Note that, the size of the snap and the snap-retention feature are enlarged for clarity. Several snap-retention features may be necessary to fully fasten the bezel to the equipment enclosure, depending on the size and shape of the bezel, and whether an additional type of fastening mechanism is employed. Also note that only one vertical column is shown in the equipment enclosure, for clarity of illustration. An equipment enclosure commonly includes at least three additional vertical columns.

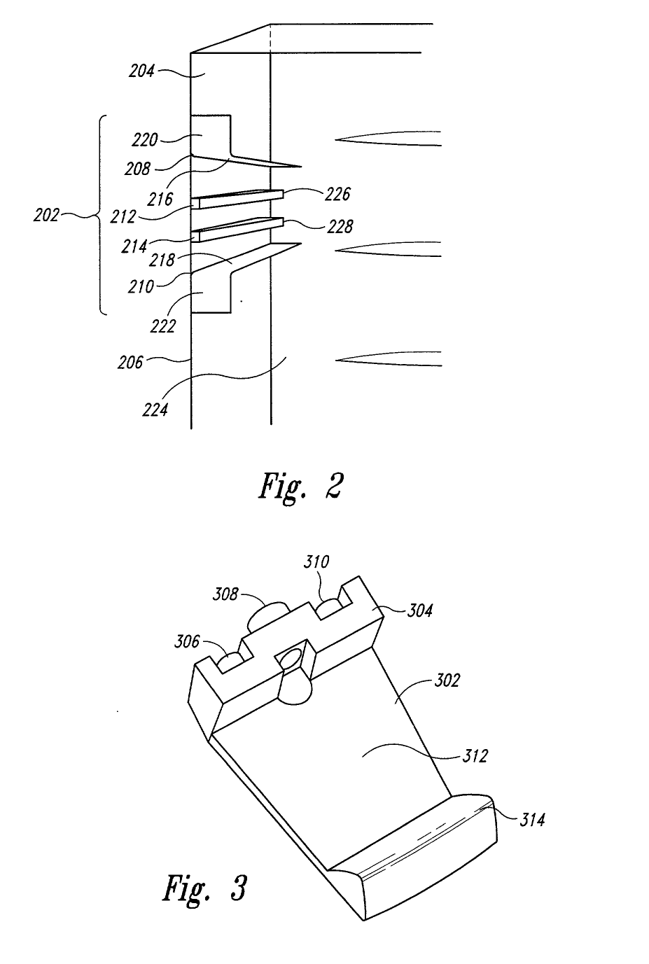

FIG. 2 shows a close-up, perspective view of a snap-retention feature molded onto the inner lip of the bezel. The snap-retention feature 202 comprises a snap-retention section 212,214,216, and 218 and a bezel-alignment section 216,218,220, and 222. The snap-retention section 212,214,216, and 218 of the snap-retention feature 202 comprises two parallel, ramp-shaped pieces 212,214, or ramps, that fasten to the snap. The bezel-alignment section 216,218,220, and 222 comprises two guide strips 208,210 that flank the ramp-shaped pieces 212,214 and guide the snap up the ramp-shaped pieces 212,214.

The guide strips 208,210 each contain a tapered section 216,218 that extends across the inner lip 204, from the outer edge to the major inner surface 224 of the bezel 206. The guide strips 208,210 cross the inner lip 204 at an angle such that, collectively, the guide strips 208,210 create a space along the inner lip 204, and in-between the tapered sections 216,218. The space tapers from the outer edge to the major inner surface 224, serving as a guide that corrects small misalignments between the bezel 206 and the equipment enclosure as the bezel 206 is fastened to the equipment enclosure. Additionally, at the end of each guide strip 208,210, opposite from the major inner surface 224, a flanged section 220,222 may extend along the outer edge of the inner lip 204 of the bezel 206.

The two ramp-shaped pieces 212,214 are spaced between the two guide strips 208,210, with the ramp-shaped pieces 212,214 rising away from the flanged section 220,222 of the guide strips 208,210. The ramp-shaped pieces 211,214 rise from the outer edge of the inner lip 204 towards the major inner surface 224 of the bezel 206. The tapered sections 216,218 of the guide strips 208,210 extend all the way across the inner lip 204 of the bezel 206 to the major inner surface 224 of the bezel 206, whereas the ramp-shaped pieces 212,214 are shorter in length, and do not extend to the major inner surface 224. The space present between the back edges 226,228 of the ramp-shaped pieces 212,214 and the major inner surface 224, makes room for the tip of the snap, which fastens to the back edges of the ramp-shaped pieces when the bezel 206 is fastened to the equipment enclosure.

FIG. 3 is a perspective view of one possible snap compatible with the bezel-retention section of the snap-retention feature. The snap 302 comprises a notched base 304 with three screw holes 306,308, and 310, and a flat, tapered tongue 312 extending to a convex tip 314. The notched base 304 and screw holes 306,308, and 310 facilitate attachment of the snap 302 to a vertical column on the front face of the equipment enclosure.

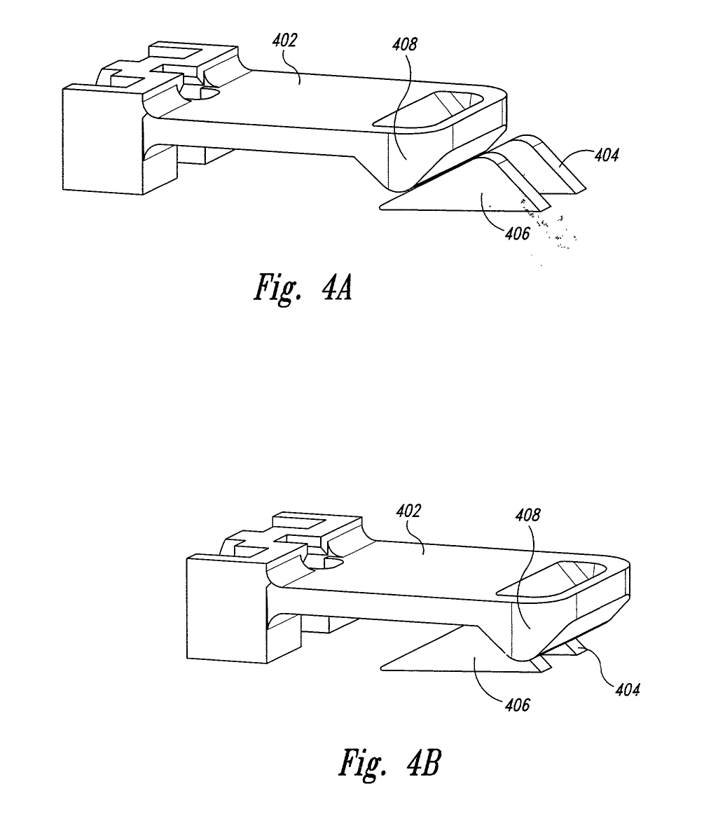

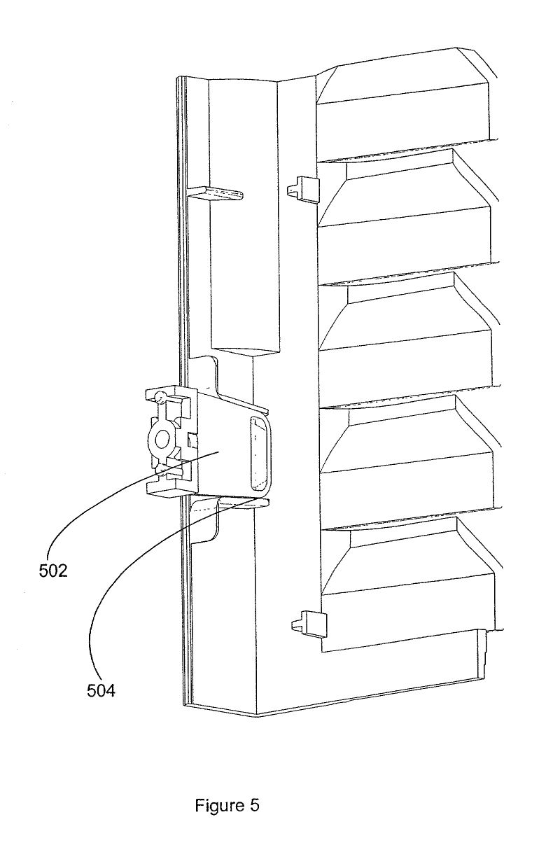

As the bezel is fastened to the equipment enclosure, the tapered tongue of the snap aligns with the guide strips of the bezel-retention section of the snap-retention feature. The guide strips guide the firmly anchored snap up the two ramp-shaped pieces between the guide strips. FIG. 4A is a perspective view showing the snap before ascending the two ramp-shaped pieces. The snap 402 is oriented so that the convex tip 408 faces the ramp-shaped pieces 404,406. Ascension of the two ramps 404,406 causes tension to build in the snap 402 as a result of increased displacement of the tip of the snap 408 from the original projection of the snap 402 from the equipment enclosure. The convex shape of the tip 408 further accentuates the displacement and the corresponding tension. The angle of the incline of the ramp-shaped pieces 404,406 determines the amount of force necessary to displace the snap 402. The steeper the angle, the more force that is necessary. Thus, the steeper the incline of the ramps, the more force required to fasten the snap 402 to the ramp-shaped pieces 404,406.

FIG. 4B is a perspective view showing the snap after cresting the ramp-shaped pieces. When the convex tip 408 of the snap 402 passes over the top of the ramp-shaped pieces 404,406, the displacement of the snap 402 is significantly reduced. Consequently, tension in the snap 402 is reduced, and the convex tip 408 of the snap 402 stays fastened to the back edges of the ramp-shaped pieces 404,406.

FIG. 5 shows the snap 502 fastened to the snap-retention section of the snap-retention feature 504. Note that the length and width of the space between the guide strips generally corresponds with the length and width of the snap 502. Also note that several features may be necessary to fully fasten one length of the bezel to the equipment enclosure.

Although the present invention has been described in terms of a particular embodiment, it is not intended that the invention be limited to this embodiment. Modifications within the spirit of the invention will be apparent to those skilled in the art. For example, the material used to construct the snap-retention feature and the snap may vary. Generally, the snap-retention feature is made from the same material as the bezel. In most cases, plastic can be used. The size and number of snap-retention features can vary depending on the size and shape of the equipment enclosure. Furthermore, the exact shapes and numbers of the different pieces of the snap-retention feature may vary as well. For instance, a snap-retention feature need not have exactly two ramp-shaped pieces. Moreover, the incline of the ramp-shaped pieces may vary depending on the predetermined amount of force desired to fasten the bezel to the equipment enclosure. The angle of the tapering of the guide strips may also vary. Different types of snaps may require a different guide-strip angling. Different surface locations may be used to attach the snap or snap-retention feature. For instance, snap-retention features may be molded to a horizontal length of the inner lip of the bezel instead of a vertical length. Additionally, snap-retention features may be molded onto several different lengths of the inner lip of the bezel. The bezel-retention mechanism of the present invention may be used by itself, or in conjunction with other bezel-retention mechanisms, for instance, a slidingmechanism, or a hinged-mechanism.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A bezel-retention system for mounting a bezel to an equipment enclosure, the system comprising:
a snap mounted to the equipment enclosure;
a snap-retention feature molded onto a bezel, the snap-retention feature including guide strips and ramps for receiving and retaining the snap.

2. The bezel-retention system of claim 1 wherein the snap-retention feature is molded onto the bezel in a single mold.

3. The bezel-retention system of claim 1 wherein the guide strips facilitate alignment of the snap and the snap-retention feature.

4. The bezel-retention system of claim 1 wherein the bezel includes an inner lip and a major inner surface.

5. The bezel-retention system of claim 4 wherein the snap-retention feature each guide strip extends along the inner lip of the bezel from the major inner surface to an outer edge of the inner lip.

6. The bezel-retention system of claim 4 wherein the snap-retention feature includes two guide strips, the guide strips extending across the inner lip such that the guide strips create a tapered space between the two guide strips, the space tapering from an outer edge of the inner lip to the major inner surface.

7. The bezel-retention system of claim 6 wherein the snap-retention feature further includes at least one ramp molded onto the bezel in the tapered space.

8. The bezel-retention system of claim 7 wherein each ramp rises from an outer edge of the inner lip of the bezel.

9. A method for fastening a bezel to an equipment enclosure, the method comprising:
mounting a snap to the equipment enclosure, the snap having a convex tip;
molding a snap-retention feature to the bezel, the snap-retention feature including one or more ramps, each ramp having a back edge; and
fastening the bezel to the equipment enclosure by pressing the snapretention feature onto the snap so that the convex tip of the snap climbs the ramps and the tip of the snap descends in contact with the back edges of the ramps in order to secure the snap within the snap-retention feature.

10. The method of claim 9 wherein molding the snap-retention feature to the bezel further comprises molding the snap-retention feature to the bezel in a single mold.

11. The method of claim 9 wherein the snap-retention feature further comprises one or more guides strips for facilitating alignment of the snap and the snap-retention feature.

12. A method for providing a bezel-fastening mechanism within an equipment enclosure, the method comprising:
mounting a snap to the equipment enclosure; and
molding a snap-retention feature to the bezel, the snap-retention feature including one or more ramps, in a position on the bezel such that, when the bezel is closed, the snap-retention feature engages and secures the snap, thereby securing the bezel to the equipment enclosure.

13. The method of claim 12 wherein molding the snap-retention feature to the bezel further comprises molding the snap-retention feature to the bezel in a single mold.

14. The method of claim 12 wherein the snap-retention feature further comprises one or more guides strips for facilitating alignment of the snap and the snap-retention feature.
